(19) United States
(12) Patent Application Publication
(10) Pub. No.: US 2022/0384878 A1
(43) Pub. Date: Dec. 1, 2022

(54) BATTERY ASSEMBLY AND ELECTRONIC VAPORIZATION DEVICE

(71) Applicant: SHENZHEN SMOORE TECHNOLOGY LIMITED, Shenzhen (CN)

(72) Inventors: Zhijia LIANG, Shenzhen (CN); Zhengjun XIE, Shenzhen (CN); Zhinan MING, Shenzhen (CN); Jun LI, Shenzhen (CN); Zhaohuan ZENG, Shenzhen (CN); Pifa SHEN, Shenzhen (CN)

(21) Appl. No.: 17/825,292

(22) Filed: May 26, 2022

(30) Foreign Application Priority Data
Jun. 1, 2021 (CN) 202110609756.6
Jun. 1, 2021 (CN) 202110610522.3

(51) Int. Cl. H01M 10/6551; H01M 10/613; H01M 10/653; H01M 10/654

(52) U.S. Cl. CPC H01M 10/6551; H01M 10/613; H01M 10/653; H01M 10/654

(57) ABSTRACT

A battery assembly of an electronic vaporization device includes: a housing; a battery core located in the housing; and a heat dissipating element located in the housing and disposed on the battery core, the heat dissipating element dissipating heat generated by the battery core. In an embodiment, a first side of the heat dissipating element is in contact with the battery core, and a second side of the heat dissipating element is in contact with the housing.

CROSS-REFERENCE TO PRIOR APPLICATION

Priority is claimed to Chinese Patent Application No. CN 202110610522.3, filed on Jun. 1, 2021, and to Chinese Patent Application No. CN 202110609756.6, filed on Jun. 1, 2021 the entire disclosure of which are hereby incorporated by reference herein.

### FIELD

This application relates to the field of electronic vaporization devices, and in particular, to a battery assembly of an electronic vaporization device and an electronic vaporization device.

### BACKGROUND

In an existing electronic vaporization device, charging and discharging currents of a battery core are small, the battery core produces less heat during use, and the requirements for temperature detection of the battery core and for an ambient temperature of the battery core are not high.

The charging speed of the existing electronic vaporization device is slow, and it generally takes more than an hour to be fully charged. Therefore, there is a growing demand for battery core fast charging technology. Due to the large charging current of the battery core fast charging technology, the amount of heat generated in a charging process by a vaporization equipment is large. A usage specification of the battery core requires that the ambient temperature cannot exceed 45° C. Therefore, in the original structural scheme, due to a large amount of heat generated by a circuit board component, the generated heat cannot be quickly dissipated, resulting in an excessively high ambient temperature inside the battery core. The high temperature of the battery core causes reduction or termination of the charging current, which affects the use of a fast charging function.

### SUMMARY

In an embodiment, the present invention provides a battery assembly of an electronic vaporization device, comprising: a housing; a battery core located in the housing; and a heat dissipating element located in the housing and disposed on the battery core, the heat dissipating element being configured to dissipate heat generated by the battery core.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is an overall schematic diagram of a vaporizer according to an embodiment of this application;

FIG. 2 is a schematic front view of a structure of a battery assembly with a housing removed according to an embodiment of this application;

FIG. 3 is a schematic rear view of a structure of the battery assembly with the housing removed according to an embodiment of this application;

FIG. 4 is a cross-sectional view of the battery assembly in FIG. 1 taken along an A-A direction;

FIG. 5 is a schematic diagram of an end surface of the battery assembly in FIG. 1; and

FIG. 6 is a schematic structural diagram of an embodiment of an electronic vaporization device of this application.

### DETAILED DESCRIPTION

In an embodiment, the present invention provides a battery assembly and an electronic vaporization device, which can reduce the ambient temperature of a surface of a battery core. In the battery assembly, a heat dissipating element is added between a battery core and a housing. The heat on the battery core is transferred to the housing and dissipated by the heat dissipating element, so that the ambient temperature of a surface of the battery core is reduced.

In an embodiment, the present invention provides a battery assembly, including: a housing; a battery core, located in the housing; and a heat dissipating element, located in the housing, disposed on the battery core, and configured to dissipate heat generated by the battery core.

A first side of the heat dissipating element is in contact with the battery core, and a second side of the heat dissipating element is in contact with the housing.

An adhesive layer is disposed between the heat dissipating element and the battery core.

A projection area of the heat dissipating element on a surface of the battery core is greater than 80% of an area of the surface of the battery core.

The battery core includes a battery core body and an electrode tab disposed on the battery core body; the heat dissipating element includes a heat dissipating layer and a heat dissipating body; and the heat dissipating layer is fitted between the battery core body and the housing, and the heat dissipating body is fitted to a surface of the electrode tab.

A first end of the heat dissipating body abuts against the electrode tab, and a second end of the heat dissipating body opposite to the first end abuts against the housing.

The material of the heat dissipating element is a graphite foam sheet.

The heat dissipating element is compressed before assembly, and gradually recovers when the heat dissipating element is located between the housing and the battery core, so as to ensure that the heat dissipating material is in full contact with the battery core and the housing.

The battery assembly further includes a bracket, and the battery core is disposed on the bracket; the bracket is provided with a through hole, so that a first surface and a second surface of the battery core opposite to each other are both completely exposed; the heat dissipating element includes a first heat dissipating layer and a second heat dissipating layer; and the first heat dissipating layer is fitted between the first surface and the housing, and the second heat dissipating layer is fitted between the second surface and the housing.

In order to resolve the above technical problems, a second technical solution provided in this application is to provide an electronic vaporization device, including: a vaporizer; and a battery assembly, configured to supply power to the vaporizer, and including the battery assembly according to any one of the foregoing.

Regarding the beneficial effect of this application, different from that of the related art, in the battery assembly provided in this application, a heat dissipating element is added between the battery core and the housing, and the heat on the battery core is transferred to the housing and dissipated by the heat dissipating element, so that the ambient temperature of a surface of the battery core is reduced.

The technical solutions in the embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

The terms “first”, “second”, and “third” in this application are used for descriptive purposes only and are not to be construed as indicating or implying relative importance or implicitly indicating the number of technical features indicated. Therefore, features defining “first”, “second”, and “third” can explicitly or implicitly include at least one of the features. In description of this application, “more” means at least two, such as two and three unless it is specifically defined otherwise. All directional indications (for example, up, down, left, right, front, back) in the embodiments of this application are only used for explaining relative position relationships, movement situations or the like between the various components in a specific posture (as shown in the accompanying drawings). If the specific posture changes, the directional indications change accordingly. In addition, the terms “include”, “have”, and any variant thereof are intended to cover a non-exclusive inclusion. For example, a process, method, system, product, or device that includes a series of steps or units is not limited to the listed steps or units, but further optionally includes a step or unit that is not listed, or further optionally includes another step or unit that is intrinsic to the process, method, product, or device.

Embodiment mentioned in the specification means that particular features, structures, or characteristics described with reference to the embodiment may be included in at least one embodiment of this application. The term appearing at different positions of the specification may not refer to the same embodiment or an independent or alternative embodiment that is mutually exclusive with another embodiment. A person skilled in the art explicitly or implicitly understands that the embodiments described in the specification may be combined with other embodiments.

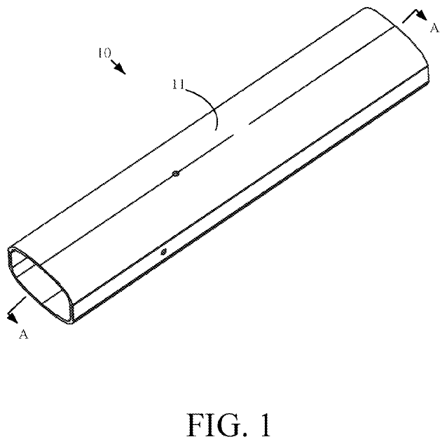

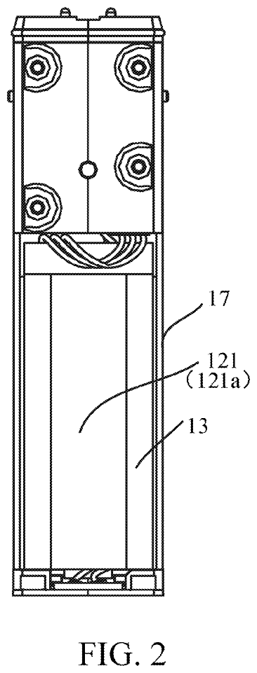

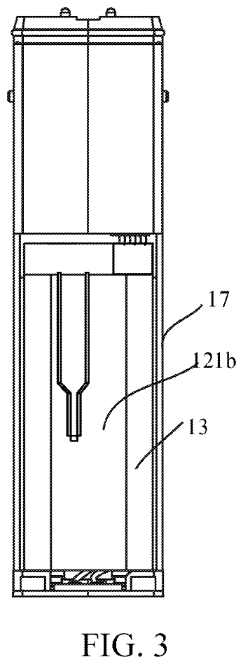

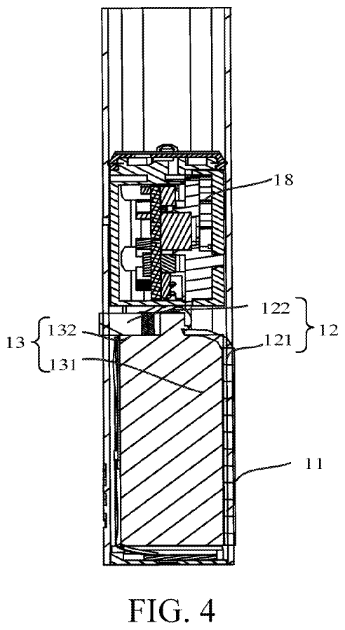

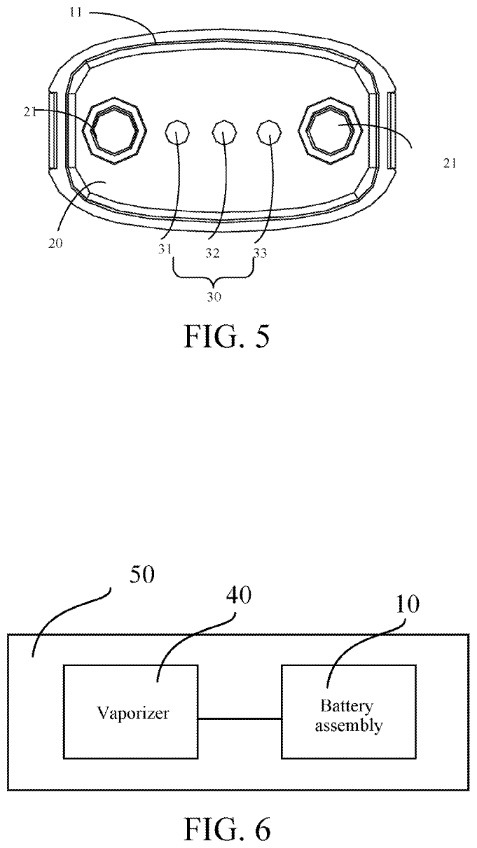

Referring to FIG. 1 to FIG. 6, FIG. 1 is an overall schematic diagram of a vaporizer according to an embodiment of this application; FIG. 2 is a schematic front view of a structure of a battery assembly with a housing removed according to an embodiment of this application; FIG. 3 is a schematic rear view of a structure of the battery assembly with the housing removed according to the embodiment of this application ; FIG. 4 is a cross-sectional view of the battery assembly in FIG. 1 taken along an A-A direction; FIG. 5 is a schematic diagram of an end surface of the battery assembly in FIG. 1; and FIG. 6 is a schematic structural diagram of an embodiment of an electronic vaporization device of this application.

Specifically, a battery assembly 10 includes: a housing 11, a heat dissipating element 12, and a battery core 13, where the battery core 13 is disposed in the housing 11. The heat dissipating element 12 is located between the housing 11 and the battery core 13, and is configured to dissipate heat generated by the battery core 13.

In the battery assembly 10 of this application, the heat dissipating element 12 is disposed on the battery core 13, so that the heat generated by the battery core 13 is quickly transferred to the housing 11 and dissipated through the housing 11 by the heat dissipating element 12, thereby reducing the ambient temperature of the battery core 13 and ensuring that the temperature of the battery core 13 is in a normal operating range.

Specifically, in an embodiment, the heat dissipating element 12 may be disposed between the battery core 13 and the housing 11, that is, a first side of the heat dissipating element 12 is in contact with the battery core 13 and a second side of the heat dissipating element 12 is in contact with the housing 11, so as to transfer the heat generated by the battery core 13 to the housing 11. Because the housing 11 is in contact with the outside air, heat can be transferred and dissipated by the air, thereby reducing the ambient temperature of the battery core 13.

In an embodiment, the heat dissipating element 12 may be fixed to a surface of the battery core 13. For example, a viscous substance is disposed on the first side of the heat dissipating element 12 close to the battery core 13, that is, on a side close to the battery core 13, the heat dissipating element 12 is fixedly bonded to the battery core 13 by the viscous substance, and then loaded into the housing 11, to prevent the heat dissipating element 12 from falling off from the battery core 13 during assembly. When the battery core 13 is assembled with the housing 11, the second side of the heat dissipating element 12, that is, a side away from the battery core 13, is brought into contact with the housing 11. Further, a non-conductive and viscous substance is selected as the viscous substance, for example, the viscous substance may be a glue, an epoxy, or the like.

In another embodiment, alternatively, a viscous substance layer may be disposed on an outer surface of the battery core 13 first, and the heat dissipating element 12 may be fixed on the battery core 13 and then loaded into the housing 11.

In another embodiment, alternatively, the heat dissipating element 12 may be fixed to a surface of the housing 11 close to the battery core 13, for example, a viscous substance is disposed on the second side of the heat dissipating element close to the housing 11, and the heat dissipating element 12 is fixedly bonded to the housing 11 by the viscous substance. In this way, when the battery core 13 is assembled with the housing 11, the first side of the heat dissipating element 12 is brought into contact with the battery core 13.

Specifically, in order to enable the heat dissipating element 12 to transfer heat from the battery core 13 to the housing 11 well, a thickness of the heat dissipating element 12 needs to be equal to or greater than an assembly distance from the battery core 13 to the housing 11.

When the thickness of the heat dissipating element 12 is equal to the assembly distance from the battery core 13 to the housing 11, the first side of the heat dissipating element 12 is in contact with the outer surface of the battery core 13, and the second side of the heat dissipating element 12 opposite to the first side is in contact with an inner surface of the housing 11. When the thickness of the heat dissipating element 12 is greater than the assembly distance from the battery core 13 to the housing 11, an accommodating groove capable of accommodating the heat dissipating element 12 may further be disposed at a position of the inner surface of the housing 11 corresponding to the heat dissipating element 12. After the battery core 13 is assembled with the housing 11, the side of the heat dissipating element 12 close to the housing 11 is at least partially embedded in the accommodating groove of the housing 11. The specific structure is not limited, as long as the heat conduction can be performed so as to reduce the ambient temperature of the surface of the battery core 13.

In an embodiment, in order to better achieve the heat dissipation effect of the battery core 13, the heat dissipating element 12 can be made to cover the surface of the battery core 13 over a large area. Specifically, a projection area of the heat dissipating element 12 on the surface of the battery core 13 can be made greater than 80% of an area of the surface of the battery core 13, that is, an area covered by the heat dissipating element 12 is greater than 80% of the outer surface of the battery core 13, thereby facilitating the heat generated on the battery core 13 to be sufficiently introduced into the heat dissipating element 12, so as to reduce the ambient temperature of the battery core 13.

Specifically, the battery core 13 includes a battery core body 131 and an electrode tab 132, the battery core body 131 stores power for driving a vaporization component, and the electrode tab 132 is electrically connected to a circuit board 18. Specifically, the electrode tab 132 is electrically connected to the circuit board 18 via a lead wire, and the circuit board 18 controls the battery core body 131 to supply power to a heating component in the vaporizer, so as to heat an aerosol generating substrate and produce an aerosol that can be inhaled by a user.

In an embodiment, the heat dissipating element 12 includes a heat dissipating layer 121 and a heat dissipating body 122. Specifically, the heat dissipating layer 121 is fitted between the battery core body 131 and the housing 11, and the heat dissipating body 122 is fitted to a surface of the electrode tab 132. The heat dissipating layer 121 may be fitted on two opposite side surfaces of the battery core body 131 or may surround the side surface of the entire battery core body 131.

The shape and size of the heat dissipating body 122 are not limited. Specifically, the heat dissipating body 122 is in a cuboid shape, one end of the battery core 13 has a protrusion portion 16, and the electrode tab 132 is disposed on the protrusion portion 16. A first end of the heat dissipating body 122 abuts against a side surface of the protrusion portion 16, and a second end of the heat dissipating body 122 opposite to the first end abuts against the housing 11. A first side surface of the heat dissipating body 122 abuts against the electrode tab 132, and a second side surface opposite to the first side surface is flush with a top surface of the protrusion portion 16. The material of the heat dissipating element 13 may be a highly thermally conductive material such as graphite, carbon nanotube, metal, or ceramic. Specifically, in this embodiment, the material of the heat dissipating element 13 is preferably a graphite foam sheet. Specifically, the graphite foam sheet is first affixed to the surface of the battery core 13 by an adhesive layer, the graphite foam sheet is compressed before assembly, and then loaded into the housing 11 together with the battery core 13. After being located between the housing 11 and the battery core 13, the graphite foam sheet is gradually recovered, ensuring that the graphite foam sheet is in full contact with the outer surface of the battery core 13 and the inner surface of the housing 11, so as to quickly conduct and dissipate the heat generated on the battery core 13 to the housing 11.

Specifically, because the heat conductivity coefficient of graphite is large, and the compressible ratio of foam is large, in an embodiment, during the process of inserting the battery core 13 into the housing 11, the heat dissipating element 12 can be compressed first, and after the assembly is completed, the heat dissipating element 12 slowly recovers but does not completely recover to a natural state, that is, the graphite foam sheet is in a compressed state. The graphite foam sheet, which is not completely recovered to its natural state, can ensure that the heat dissipating element 12 is in sufficient and tight contact with the battery core 13 and the housing 11, respectively, thereby fixing the battery core 13. Therefore, an original foam sheet for fixing between the battery core 13 and the housing 11 can also be omitted, which reduces the cost of the battery assembly 10.

Referring to FIG. 2 and FIG. 3, the battery assembly 10 of this application further includes a bracket 17, and the battery core 13 is disposed on the bracket 17. Specifically, the bracket 17 has a through hole, and the battery core 13 is embedded in the through hole, so that a first surface and a second surface of the battery core 13 opposite to each other are both completely exposed. The heat dissipating layer 121 includes a first heat dissipating layer 121a and a second heat dissipating layer 121b. The first heat dissipating layer 121a is fitted between the first surface of the battery core 13 and the housing 11, and the second heat dissipating layer 121b is fitted between the second surface of the battery core 13 and the housing 11. In an embodiment, the first heat dissipating layer 121a covers the entire first surface of the battery core 13, and the second heat dissipating layer 121b covers the entire second surface of the battery core 13. In an embodiment, the bracket 17 further includes a mounting groove spaced from the through hole, the battery core 13 is embedded in the through hole, and the circuit board 18 is disposed in the mounting groove. One end of the bracket 17 is a connection portion, and an electrode is disposed on the connection portion for connecting to the vaporizer.

Specifically, referring to FIG. 1, the housing 11 is disposed along an axial direction of the battery core 13 to dissipate the heat conducted by the battery core 13 through the heat dissipating element 12, so that the ambient temperature of the surface of the battery core 13 is under normal operating conditions of the battery core 13. The material of the housing 11 is a metal or an alloy.

Specifically, referring to FIG. 5, the battery assembly 10 of this application further includes a charging element 20, and the charging element 20 is disposed at an end of the bracket 17 away from the connection portion and is connected to the circuit board 18 by a wire. The charging element 20 includes a positive electrode 31, a negative electrode 32, and a protective electrode 33, and is configured to connect to an external charging head to charge the battery core 13; and the charging element 20 further includes an indicator light 21, when the battery core 13 is charged, the indicator light 21 is displayed in red, and when the battery core 13 is fully charged, the indicator light 21 is displayed in green. In an embodiment, two indicator lights 21 are disposed on opposite two sides of end surfaces of the charging element 20, respectively.

Specifically, referring to FIG. 6, FIG. 6 is a schematic structural diagram of an embodiment of an electronic vaporization device of this application. Specifically, the electronic vaporization device 50 includes a vaporizer 40 and a battery assembly 10. The battery assembly 10 is configured to supply power to the vaporizer 40, and the battery assembly 10 includes the battery assembly 10 shown in any of the foregoing embodiments in FIG. 1 to FIG. 5.

The foregoing descriptions are merely implementations of this application, and the patent scope of this application is not limited thereto. All equivalent structure or process changes made according to the content of this specification and accompanying drawings in this application or by directly or indirectly applying this application in other related technical fields shall fall within the protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A battery assembly of an electronic vaporization device, comprising:
a housing;
a battery core located in the housing; and
a heat dissipating element located in the housing and disposed on the battery core, the heat dissipating element being configured to dissipate heat generated by the battery core.

2. The battery assembly of claim 1, wherein a first side of the heat dissipating element is in contact with the battery core, and a second side of the heat dissipating element is in contact with the housing.

3. The battery assembly of claim 1, further comprising:
an adhesive layer disposed between the heat dissipating element and the battery core.

4. The battery assembly of claim 1, wherein a projection area of the heat dissipating element on a surface of the battery core is greater than 80% of an area of the surface of the battery core.

5. The battery assembly of claim 1, wherein the battery core comprises a battery core body and an electrode tab disposed on the battery core body, and
wherein the heat dissipating element comprises a heat dissipating layer and a heat dissipating body, the heat dissipating layer being fitted between the battery core body and the housing, and the heat dissipating body being fitted to a surface of the electrode tab.

6. The battery assembly of claim 5, wherein a first end of the heat dissipating body abuts the electrode tab, and a second end of the heat dissipating body abuts the housing.

7. The battery assembly of claim 1, wherein a material of the heat dissipating element comprises a graphite foam sheet.

8. The battery assembly of claim 7, wherein the graphite foam sheet comprises a compressed graphite foam sheet.

9. The battery assembly of claim 1, further comprising:
a bracket,
wherein the battery core is disposed on the bracket,
wherein the bracket comprises a through hole such that a first surface and a second surface of the battery core opposite each other are both completely exposed, and
wherein the heat dissipating element comprises a first heat dissipating layer and a second heat dissipating layer, the first heat dissipating layer being fitted between the first surface and the housing, and the second heat dissipating layer being fitted between the second surface and the housing.

10. An electronic vaporization device, comprising:
a vaporizer; and
the battery assembly of claim 1, the batter assembly being configured to supply power to the vaporizer.
